(19) United States
(12) Patent Application Publication
(10) Pub. No.: US 2026/0074489 A1
(43) Pub. Date: Mar. 12, 2026

(54) DISTRIBUTED SOLID STATE TRANSFORMER (SST)-BASED POWER DISPENSING NETWORK

(71) Applicant: Amperesand Pte Ltd., Singapore (SG)

(72) Inventors: Gil Lampong OPINA, JR., Singapore (SG); Howe Li Yeo, Singapore (SG)

(21) Appl. No.: 18/827,424

(22) Filed: Sep. 6, 2024

(51) Int. Cl. H02B 1/015; H02M 3/335

(52) U.S. Cl. CPC H02B 1/015; H02M 3/33576

(57) ABSTRACT

A distributed SST-based power dispensing network, comprising a main cell system including a main cell and a main cell controller, the main cell having main cell converter circuitry including a primary bridge of a dual active bridge (DAB), the main cell controller configured to control the primary bridge and configured to activate main cell forward mode control circuitry or main cell reverse mode control circuitry perform based on a direction of power flow; and a power dispensing system including a power dispenser and a power dispenser controller, the power dispenser having power dispenser converter circuitry including a secondary bridge of the DAB, the power dispenser controller configured to control the secondary bridge and configured to activate power dispenser forward mode control circuitry or power dispenser reverse mode control circuitry based on the direction of power flow.

### TECHNICAL FIELD

This disclosure pertains to a distributed power dispensing network, which includes a main substation that obtains power from an electric grid, transforms the power, and delivers the transformed power to one or more power dispensers of a power dispensing system. In some embodiments, the main substation and the one or more power dispensers of the power dispensing system are remote from each other.

### BACKGROUND

Power electronics provide a newfound resiliency to the energy infrastructure. For example, power electronics transform power from one voltage and/or shape to another, thereby efficiently supplying more flexible energy solutions. Various devices such as vehicles need to be charged. Accordingly, safe and efficient power dispensers using power electronics are needed.

### SUMMARY

A claimed solution overcomes problems specifically arising in the realm of power electronics, in particular, to a distributed solid state transformer (SST)-based power dispensing network. The distributed SST-based power dispensing network includes one or more main cell systems at a main substation and one or more power dispenser systems. Each main cell system includes a main cell and a main cell controller. Each power dispensing system includes a power dispenser and a power dispenser controller. Each power dispensing system may be contained separate and remote from the main substation and from each other.

In some embodiments, each of the main cell system and the power dispensing system comprises converter circuitry to obtain, transform, and transmit power. A main cell controller controls the main cell of the main cell system. A power dispenser controller controls the power dispenser of the power dispensing system. In an SST-based architecture, each main cell includes main cell converter circuitry, which may include a primary bridge of a dual active bridge (DAB). Each power dispenser of a power dispensing system includes power dispenser converter circuitry, which may include DAB magnetics (e.g., a transformer) and a secondary bridge of a DAB.

The main cell converter circuitry and the power dispenser converter circuitry may operate under different voltage ranges. For example, the main cell converter circuitry may operate in the medium voltage (MV) range, and the power dispenser converter circuitry may operate in the low voltage (LV) range. In some embodiments, the MV range may include voltage levels between approximately 10 kilovolts (KV) and 100 KV. In some embodiments, each main cell may operate using MV levels around approximately 11 KV, 22 KV, or 33 KV. Although each main cell is being described to operate in the MV range, main cells may operate in other voltage ranges, such as high voltage (HV) range. In some embodiments, the LV range may include voltage levels between approximately 100 volts (V) and 2 KV. In some embodiments, the power dispenser may operate using LV levels around approximately 1100 V.

In some embodiments, a main cell of a main cell system at the main substation obtains power from an electric grid, transforms the power into different forms such as direct current (DC) or alternating current (AC) and/or different voltages, and delivers the transformed power via transmission lines to a respective power dispenser. The power dispenser receives the power from the transmission lines, transforms the power, and delivers the transformed power to an entity, device, or load (hereinafter “entity”). An entity may include a power storage entity (such as a battery) or an actively consuming entity (e.g., a motor).

In some embodiments, the main substation includes one or more main cells, each main cell being configured to supply power to a respective power dispenser. Each main cell may include an MV active front end (AFE), an MV DC link, and/or an MV bridge (the primary bridge of a DAB). In some embodiments, the MV AFE includes a rectifier that converts AC power to DC power. The MV DC link connects the DC power to the MV bridge. In some embodiments, the MV DC link smooths the DC power signal, reduces transient signals, and reduces fluctuations. In some embodiments, the MV bridge includes a set of switches that may be controlled in a forward direction to operate as an inverter that converts the DC power to AC power. The AC power may be transmitted on transmission lines to a respective power dispenser.

Each power dispenser may be connected via the transmission lines to a respective main cell at the main substation. Each power dispenser may include power magnetics (e.g., DAB magnetics) and an LV bridge (the secondary bridge of a DAB). The DAB magnetics may include one or more transformers, including one or more capacitors and/or inductors. The DAB magnetics may include single phase transformers and/or include a single core with double windings. In some embodiments, the DAB magnetics may be configured to adjust the voltage levels of the AC signal, in the forward direction from MV voltage levels to LV voltage levels. In some embodiments, the LV bridge includes a set of switches that may be controlled in a forward mode to operate as a rectifier that converts the AC power to DC power, which may be supplied to an entity.

In some embodiments, the main cell controller generates main cell gate signals to control the switching operations of the set of switches of the MV bridge of each main cell. The main cell gate signals may include main cell converter circuitry waveforms that control attributes such as duty cycles and/or phase shift modes, including any or all of a single-phase shift (SPS), a double phase shift (DPS), a triple phase shift (TPS), an extended phase shift (EPS), and/or any other phase shift modes. In some embodiments, the main cell converter circuitry waveforms are pulse width modulation (PWM) waveforms. The main cell converter circuitry waveforms may control switching states between complementary pairs of switches of each MV bridge. For example, the switching states may indicate an ON or OFF status of each of the switches of each MV bridge. Therefore, the main cell converter circuitry waveforms control power flow through each MV bridge.

In some embodiments, the power dispenser controller generates power dispenser gate signals to control switching operations of the set of switches of the LV bridge of each power dispenser. The power dispenser gate signals may include power dispenser converter circuitry waveforms that control attributes such as duty cycles and/or phase shift modes, including any or all of a single-phase shift (SPS), a double phase shift (DPS), a triple phase shift (TPS), an extended phase shift (EPS), and/or any other phase shift modes. In some embodiments, the power dispenser converter circuitry waveforms are pulse width modulation (PWM) waveforms. The power dispenser converter circuitry waveforms may control switching states between complementary pairs of switches of each LV bridge. For example, the switching states may indicate an ON or OFF status of each of the switches of each LV bridge. Therefore, the power dispenser converter circuitry waveforms control power flow through each MV bridge. The power dispenser gate signals may be analogous to the main cell gate signals.

By maintaining the main cell and corresponding power dispenser in separate containers, potential benefits include increasing the overall power density at both the main cell and the power dispenser, improving safety via galvanic isolation, storage flexibility, and adaptability to meet varying physical and electrical demands of the entity. The increase of the overall power density may be due in part to a required creepage and clearance distance between the MV and LV circuits if the MV and LV circuits were housed together. The required clearance distance may be on an order of 10 millimeters (mm) or 100 mm as regulated by agencies such as International Electrotechnical Commission (IEC) and Underwriters Laboratories (UL). Because the MV and LV circuits are remote, the creepage and clearance distance requirements are reduced or eliminated. Additionally, the main cell may be stored in various locations, such as underground locations.

By housing the main cell system and the power dispensing system in separate containers, synchronization of switching operations may be needed to support power transmission. The synchronization of power transmission may include obtaining a direction of power flow, coordinating the operating modes depending on the direction of power flow, and synchronizing the timing of switching operations of the MV bridge and LV bridge. The operating modes include a forward mode when the direction of power flow is going from the main cell system to the power dispensing system, and a reverse mode when the direction of power flow is going from the power dispensing system to the main cell system. During the different operating modes, different control circuitry within each main cell and power dispenser may be activated.

To synchronize the timing of switching operations of the MV bridge and LV bridge during forward mode, the main cell controller may operate in an independent mode and the power dispenser controller may operate in a dependent mode. When operating in independent mode, the main cell controller independently generates main cell converter circuitry waveforms to control the MV bridge. When operating in dependent mode, the power dispenser controller generates power dispenser converter circuitry waveforms to control the LV bridge in a process that depends upon or is triggered by a power dispenser trigger signal. The power dispenser trigger signal may include rising edges of certain secondary side voltages of the magnetic component circuitry. The rising edges may trigger a digital counter which triggers a state machine to change a state. The change of state triggers generating of the power dispenser converter circuitry waveforms.

To synchronize the timing of switching operations of the MV bridge and LV bridge during reverse mode, the power dispenser controller may operate in an independent mode while the main cell controller may operate in a dependent mode. When operating in independent mode, the power dispenser controller independently generates power dispenser converter circuitry waveforms. When operating in dependent mode, the main cell controller generates main cell converter circuitry waveforms in a process that depends upon or is triggered by a main cell trigger signal. The main cell trigger signal may include primary side currents exceeding a current threshold. The primary side currents may be measured at the primary side of the DAB magnetics, specifically, at the primary side of the transformers. When primary side currents exceed the current threshold, a time-controlled state machine is caused to change a state. The change in state triggers generating of the main cell converter circuitry waveforms.

In this manner, the main cell controller and the power dispenser controller synchronize power transmission in forward and reverse directions of power flow in a closed loop manner. Therefore, the distributed power dispensing network confers the benefits of maintaining the main substation remote from the power dispensing system, without compromising power transmission between the main cells and the power dispensers.

The main cell controller and/or power dispenser controller may also configure the main cell and power dispenser converter circuitry waveforms to regulate main cell and/or power dispenser voltages, whether the distributed power dispensing network is operating in forward mode or reverse mode. Voltage regulation may be effected by adjusting the duty cycles of the MV bridge output waveforms or LV bridge output waveforms. Alternatively, the distributed power dispensing network may use voltage choppers.

Embodiments of the invention implement a distributed solid state transformer (SST)-based power dispensing network. The distributed SST-based power dispensing network comprises a main cell system including a main cell and a main cell controller, the main cell having main cell converter circuitry, the main cell converter circuitry including a primary bridge of a dual active bridge (DAB), the main cell controller configured to control the primary bridge, the main cell controller configured to activate main cell forward mode control circuitry or main cell reverse mode control circuitry perform based on a direction of power flow. The distributed SST-based power dispensing network comprises a power dispensing system including a power dispenser and a power dispenser controller, the power dispenser having power dispenser converter circuitry, the power dispenser circuitry including a secondary bridge of the DAB, the power dispenser controller configured to control the secondary bridge, the power dispenser controller configured to activate power dispenser forward mode control circuitry or power dispenser reverse mode control circuitry based on the direction of power flow.

In some embodiments, the main cell converter circuitry comprises a medium voltage (MV) bridge and the power dispenser converter circuitry comprises a low voltage (LV) bridge/

In some embodiments, the power dispenser converter circuitry comprises a transformer between the MV bridge and the LV bridge.

In some embodiments, the activating of the main cell forward mode control circuitry comprises the main cell forward mode control circuitry independently generating main cell converter circuitry waveforms that regulate MV switching operations of switches within the MV bridge; and the activating of the power dispenser forward mode control circuitry comprises the power dispenser forward mode control circuitry dependently generating power dispenser converter circuitry waveforms that regulate LV switching operations of switches within the LV bridge.

In some embodiments, the power dispenser forward mode control circuitry generates the power dispenser converter circuitry waveforms in response to a power dispenser trigger signal that controls a phase shift angle.

In some embodiments, the power dispenser trigger signal is based on a rising edge of a secondary side voltage corresponding to a secondary side of the magnetic component circuitry.

In some embodiments, the power dispenser forward mode control circuitry in response to the power dispenser trigger signal, triggers a digital counter, which controls a state machine to change a state, the changed state causing generating of the power dispenser converter circuitry waveforms.

In some embodiments, the activating of the main cell reverse mode control circuitry comprises the main cell reverse mode control circuitry causing dependently generating main cell converter circuitry waveforms that regulate MV switching operations of switches within the MV bridge; and the activating of the power dispenser reverse mode control circuitry comprises the power dispenser reverse mode control circuitry independently generating power dispenser converter circuitry waveforms that regulate LV switching operations of switches within the LV bridge.

In some embodiments, the main cell reverse mode control circuitry generates the main cell converter circuitry waveforms in response to a main cell trigger signal that controls a phase shift angle.

In some embodiments, the main cell trigger signal is based on a primary side current corresponding to a primary side of the magnetic component circuitry.

In some embodiments, the main cell trigger signal is based on a comparison of the primary side current against a threshold current.

In some embodiments, the main cell reverse mode control circuitry in response to the main cell trigger signal triggers a state machine to change a state, the changed state causing generating of the main cell converter circuitry waveforms.

In some embodiments, the main cell system and the power dispensing system are separately housed in different physical containers.

In some embodiments, the main cell comprises a main cell communication interface and the power dispenser comprises a power dispenser communication interface, and wherein the direction of the power flow is communicated wirelessly from the power dispenser communication interface to the main cell communication interface.

In some embodiments, the main cell converter circuitry further comprises active front ends (AFEs) and filtering components between the first bridges and the AFEs.

In some embodiments, the power dispenser converter circuitry further comprises direct current (DC)-DC converters connected to the second bridges.

In some embodiments, the power dispenser converter circuitry further comprises harmonic filtering components.

Embodiments of the invention implement a method by a distributed SST-based power dispensing network, the distributed SST-based power dispensing network comprising a main substation and a power dispensing system, the main substation comprising a main cell system including a main cell and a main cell controller, the main cell having main cell converter circuitry, the main cell converter circuitry including a primary bridge of a dual active bridge (DAB), the main cell controller configured to control the primary bridge, the power dispensing system including a power dispenser and a power dispenser controller, the power dispenser having power dispenser converter circuitry, the power dispenser circuitry including a secondary bridge of the DAB, the power dispenser controller configured to control the secondary bridge. The method includes activating, by the main cell controller, main cell forward mode control circuitry or main cell reverse mode control circuitry perform based on a direction of power flow; and activating, by the power dispenser controller, power dispenser forward mode control circuitry or power dispenser reverse mode control circuitry based on the direction of power flow.

In some embodiments, the method further comprises transmitting power, at a medium voltage (MV) bridge of the main cell converter circuitry, at a medium voltage level and transmitting power, at a low voltage (LV) bridge of the power dispenser converter circuitry, at a low voltage level.

In some embodiments, the method further comprises converting power from the medium voltage level to the low voltage level by a transformer between the MV bridge and the LV bridges.

In some embodiments, the activating of the main cell forward mode control circuitry comprises the main cell forward mode control circuitry independently generating main cell converter circuitry waveforms that regulate MV switching operations of switches within the MV bridge; and the activating of the power dispenser forward mode control circuitry comprises the power dispenser forward mode control circuitry dependently generating power dispenser converter circuitry waveforms that regulate LV switching operations of switches within the LV bridge.

In some embodiments, the method further comprises generating, by the power dispenser forward mode control circuitry, the power dispenser converter circuitry waveforms in response to a power dispenser trigger signal that controls a phase shift angle.

In some embodiments, the power dispenser trigger signal is based on a rising edge of a secondary side voltage corresponding to a secondary side of the magnetic component circuitry.

In some embodiments, the method further comprises dispensing power transmitted through the power dispenser converter circuitry at direct current (DC)-DC converters.

In some embodiments, the method further comprises performing harmonic filtering of any harmonics at the power dispenser converter circuitry.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 is a block diagram of a distributed power dispensing network, in accordance with some embodiments of the present invention.

FIG. 2 is a diagram of a set of main cells of a main substation of the distributed power dispensing network, in accordance with to some embodiments of the present invention.

FIG. 3 is a diagram of a set of power dispensers of a set of power dispensing systems of the distributed power dispensing network, in accordance with some embodiments of the present invention.

FIG. 4A is a diagram of a distributed power dispensing network including a main cell system and a power dispensing system, in accordance with some embodiments of the present invention.

FIG. 4B is a diagram of a power dispensing system, in accordance with some embodiments of the present invention.

FIG. 5 is a block diagram of a main cell controller that controls operations of the main cell, in accordance with some embodiments of the present invention.

FIG. 6 is a block diagram of a power dispenser controller that controls operations of a power dispenser of the power dispensing system, in accordance with some embodiments of the present invention.

FIG. 7A is a flowchart of an example method of power transmission synchronization by the power dispensing system in forward mode, in accordance with some embodiments of the present invention.

FIG. 7B is a diagram illustrating example low voltage (LV) bridge output waveforms, in accordance with some embodiments of the present invention.

FIG. 8A is a diagram illustrating example circuitry of the main cell controller for power transmission synchronization in reverse mode, in accordance with some embodiments of the present invention.

FIG. 8B is a flowchart of an example method of power transmission synchronization by a main cell system in reverse mode, in accordance with some embodiments of the present invention.

FIG. 8C is a diagram illustrating example medium voltage (MV) bridge output waveforms, in accordance with some embodiments of the present invention.

### DETAILED DESCRIPTION

A claimed solution overcomes problems specifically arising in the realm of power electronics, in particular, to a distributed solid state transformer (SST)-based power dispensing network. The distributed SST-based power dispensing network includes one or more main cell systems at a main substation and one or more power dispenser systems. Each main cell system includes a main cell and a main cell controller. Each power dispensing system includes a power dispenser and a power dispenser controller. Each power dispensing system may be contained separate and remote from the main substation and from each other.

In some embodiments, each of the main cell system and the power dispensing system comprises converter circuitry to obtain, transform, and transmit power. A main cell controller controls the main cell of the main cell system. A power dispenser controller controls the power dispenser of the power dispensing system. In an SST-based architecture, each main cell includes main cell converter circuitry, which may include a primary bridge of a dual active bridge (DAB). Each power dispenser of a power dispensing system includes power dispenser converter circuitry, which may include DAB magnetics (e.g., a transformer) and a secondary bridge of a DAB.

The main cell converter circuitry and the power dispenser converter circuitry may operate under different voltage ranges. For example, the main cell converter circuitry may operate in the medium voltage (MV) range, and the power dispenser converter circuitry may operate in the low voltage (LV) range. In some embodiments, the MV range may include voltage levels between approximately 10 kilovolts (KV) and 100 KV. In some embodiments, each main cell may operate using MV levels around approximately 11 KV, 22 KV, or 33 KV. Although each main cell is being described to operate in the MV range, main cells may operate in other voltage ranges, such as high voltage (HV) range. In some embodiments, the LV range may include voltage levels between approximately 100 volts (V) and 2 KV. In some embodiments, the power dispenser may operate using LV levels around approximately 1100 V.

In some embodiments, a main cell of a main cell system at the main substation obtains power from an electric grid, transforms the power into different forms such as direct current (DC) or alternating current (AC) and/or different voltages, and delivers the transformed power via transmission lines to a respective power dispenser. The power dispenser receives the power from the transmission lines, transforms the power, and delivers the transformed power to an entity, device, or load (hereinafter “entity”). An entity may include a power storage entity (such as a battery) or an actively consuming entity (e.g., a motor).

In some embodiments, the main substation includes one or more main cells, each main cell being configured to supply power to a respective power dispenser. Each main cell may include an MV active front end (AFE), an MV DC link, and/or an MV bridge (the primary bridge of a DAB). In some embodiments, the MV AFE includes a rectifier that converts AC power to DC power. The MV DC link connects the DC power to the MV bridge. In some embodiments, the MV DC link smooths the DC power signal, reduces transient signals, and reduces fluctuations. In some embodiments, the MV bridge includes a set of switches that may be controlled in a forward direction to operate as an inverter that converts the DC power to AC power. The AC power may be transmitted on transmission lines to a respective power dispenser.

Each power dispenser may be connected via the transmission lines to a respective main cell at the main substation. Each power dispenser may include power magnetics (e.g., DAB magnetics) and an LV bridge (the secondary bridge of a DAB). The DAB magnetics may include one or more transformers, including one or more capacitors and/or inductors. The DAB magnetics may include single phase transformers and/or include a single core with double windings. In some embodiments, the DAB magnetics may be configured to adjust the voltage levels of the AC signal, in the forward direction from MV voltage levels to LV voltage levels. In some embodiments, the LV bridge includes a set of switches that may be controlled in a forward mode to operate as a rectifier that converts the AC power to DC power, which may be supplied to an entity.

In some embodiments, the main cell controller generates main cell gate signals to control the switching operations of the set of switches of the MV bridge of each main cell. The main cell gate signals may include main cell converter circuitry waveforms that control attributes such as duty cycles and/or phase shift modes, including any or all of a single-phase shift (SPS), a double phase shift (DPS), a triple phase shift (TPS), an extended phase shift (EPS), and/or any other phase shift modes. In some embodiments, the main cell converter circuitry waveforms are pulse width modulation (PWM) waveforms. The main cell converter circuitry waveforms may control switching states between complementary pairs of switches of each MV bridge. For example, the switching states may indicate an ON or OFF status of each of the switches of each MV bridge. Therefore, the main cell converter circuitry waveforms control power flow through each MV bridge.

In some embodiments, the power dispenser controller generates power dispenser gate signals to control switching operations of the set of switches of the LV bridge of each power dispenser. The power dispenser gate signals may include power dispenser converter circuitry waveforms that control attributes such as duty cycles and/or phase shift modes, including any or all of a single-phase shift (SPS), a double phase shift (DPS), a triple phase shift (TPS), an extended phase shift (EPS), and/or any other phase shift modes. In some embodiments, the power dispenser converter circuitry waveforms are pulse width modulation (PWM) waveforms. The power dispenser converter circuitry waveforms may control switching states between complementary pairs of switches of each LV bridge. For example, the switching states may indicate an ON or OFF status of each of the switches of each LV bridge. Therefore, the power dispenser converter circuitry waveforms control power flow through each MV bridge. The power dispenser gate signals may be analogous to the main cell gate signals.

By maintaining the main cell and corresponding power dispenser in separate containers, potential benefits include increasing the overall power density at both the main cell and the power dispenser, improving safety via galvanic isolation, storage flexibility, and adaptability to meet varying physical and electrical demands of the entity. The increase of the overall power density may be due in part to a required creepage and clearance distance between the MV and LV circuits if the MV and LV circuits were housed together. The required clearance distance may be on an order of 10 millimeters (mm) or 100 mm as regulated by agencies such as International Electrotechnical Commission (IEC) and Underwriters Laboratories (UL). Because the MV and LV circuits are remote, the creepage and clearance distance requirements are reduced or eliminated. Additionally, the main cell may be stored in various locations, such as underground locations.

By housing the main cell system and the power dispensing system in separate containers, synchronization of switching operations may be needed to support power transmission. The synchronization of power transmission may include obtaining a direction of power flow, coordinating the operating modes depending on the direction of power flow, and synchronizing the timing of switching operations of the MV bridge and LV bridge. The operating modes include a forward mode when the direction of power flow is going from the main cell system to the power dispensing system, and a reverse mode when the direction of power flow is going from the power dispensing system to the main cell system. During the different operating modes, different control circuitry within each main cell and power dispenser may be activated.

To synchronize the timing of switching operations of the MV bridge and LV bridge during forward mode, the main cell controller may operate in an independent mode and the power dispenser controller may operate in a dependent mode. When operating in independent mode, the main cell controller independently generates main cell converter circuitry waveforms to control the MV bridge. When operating in dependent mode, the power dispenser controller generates power dispenser converter circuitry waveforms to control the LV bridge in a process that depends upon or is triggered by a power dispenser trigger signal. The power dispenser trigger signal may include rising edges of certain secondary side voltages of the magnetic component circuitry. The rising edges may trigger a digital counter which triggers a state machine to change a state. The change of state triggers generating of the power dispenser converter circuitry waveforms.

To synchronize the timing of switching operations of the MV bridge and LV bridge during reverse mode, the power dispenser controller may operate in an independent mode while the main cell controller may operate in a dependent mode. When operating in independent mode, the power dispenser controller independently generates power dispenser converter circuitry waveforms. When operating in dependent mode, the main cell controller generates main cell converter circuitry waveforms in a process that depends upon or is triggered by a main cell trigger signal. The main cell trigger signal may include primary side currents exceeding a current threshold. The primary side currents may be measured at the primary side of the DAB magnetics, specifically, at the primary side of the transformers. When primary side currents exceed the current threshold, a time-controlled state machine is caused to change a state. The change in state triggers generating of the main cell converter circuitry waveforms.

In this manner, the main cell controller and the power dispenser controller synchronize power transmission in forward and reverse directions of power flow in a closed loop manner. Therefore, the distributed power dispensing network confers the benefits of maintaining the main substation remote from the power dispensing system, without compromising power transmission between the main cells and the power dispensers.

The main cell controller and/or power dispenser controller may also configure the main cell and power dispenser converter circuitry waveforms to regulate main cell and/or power dispenser voltages, whether the distributed power dispensing network is operating in forward mode or reverse mode. Voltage regulation may be effected by adjusting the duty cycles of the MV bridge output waveforms or LV bridge output waveforms. Alternatively, the distributed power dispensing network may use voltage choppers.

The foregoing figures further illustrate these concepts.

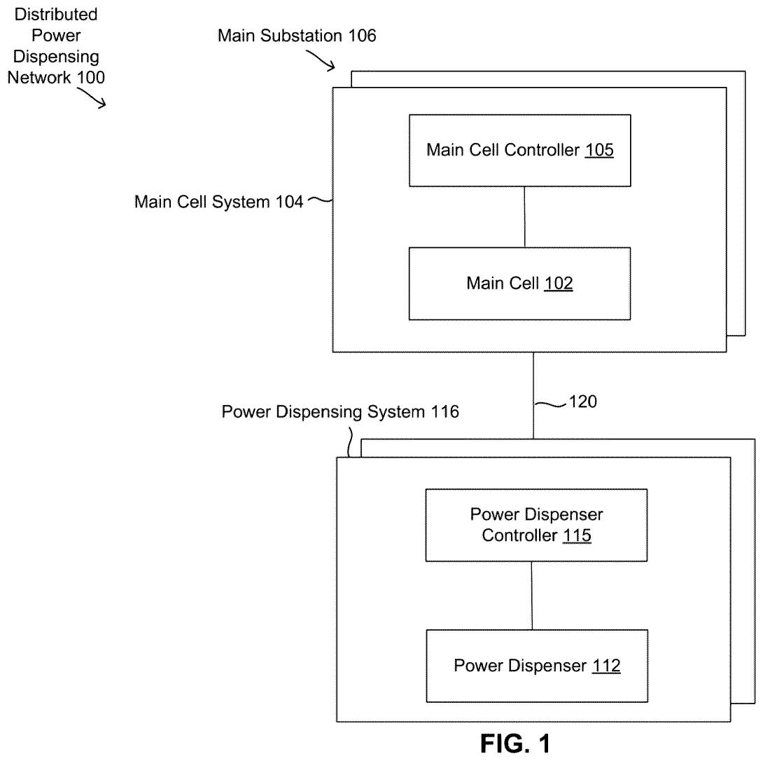

FIG. 1 is a block diagram of an example distributed power dispensing network 100, in accordance with some embodiments of the present invention. The distributed power dispensing network 100 includes a main substation 106 coupled to one or more power dispensing systems 116.

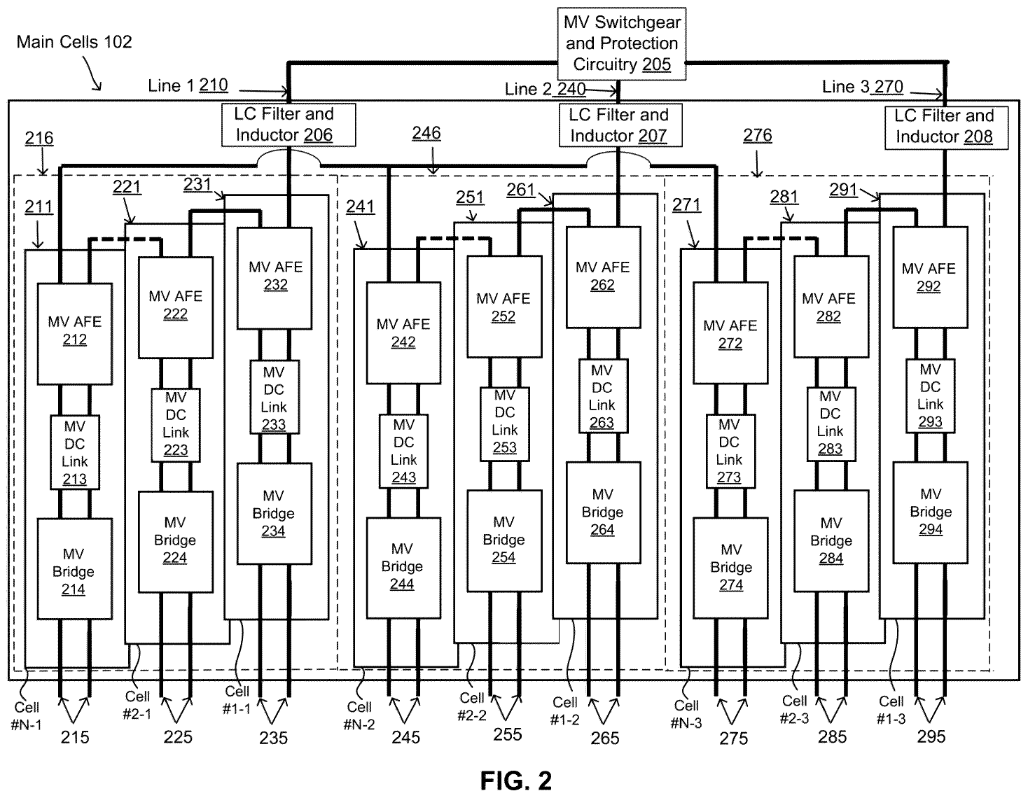

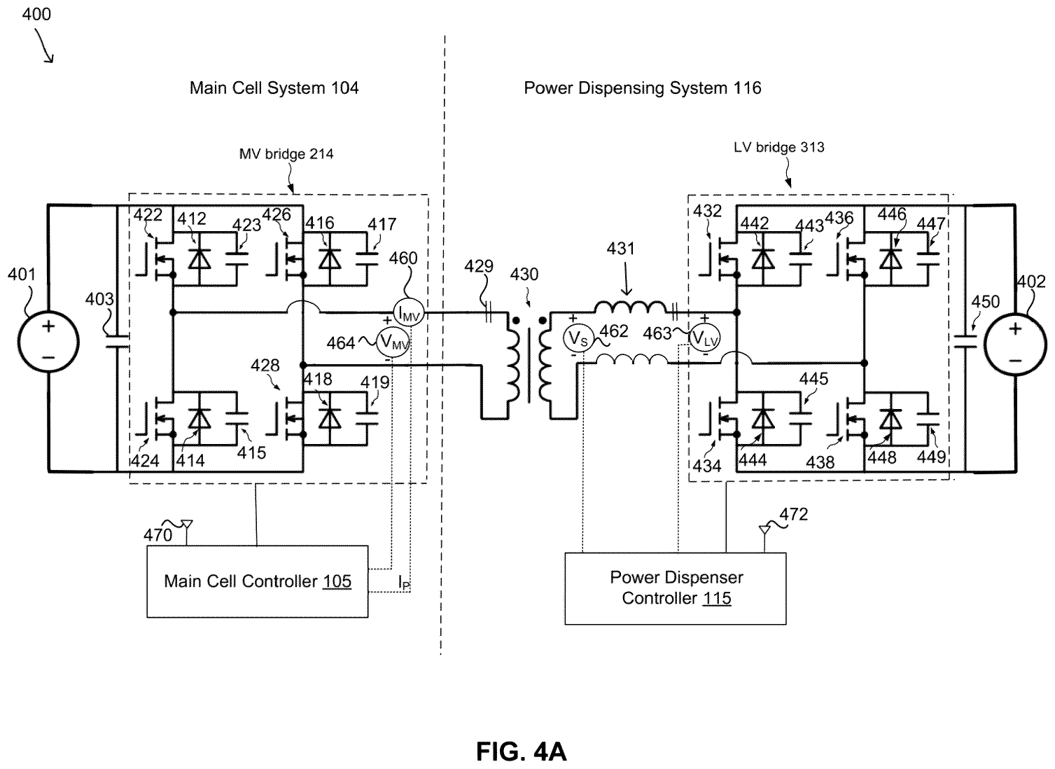

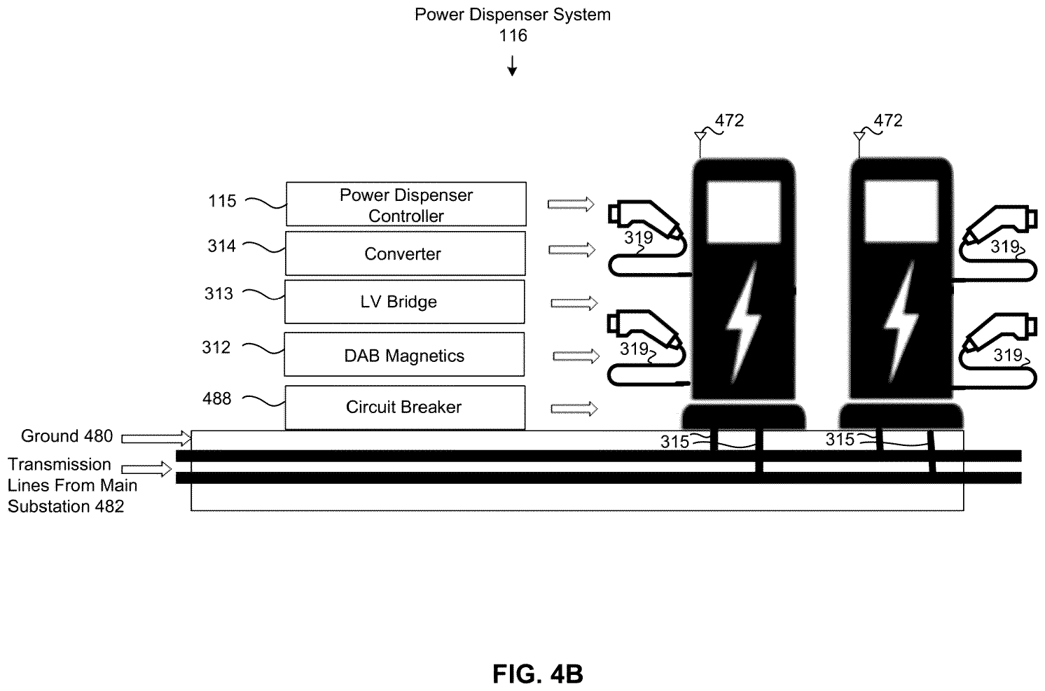

The main substation 106 includes one or more main cell systems 104, in accordance with some embodiments of the present invention. Each main cell system 104 includes a main cell 102 and a main cell controller 105. In some embodiments, the main cell 102 includes main cell converter circuitry, which may correspond to a primary bridge of a DAB, as illustrated in FIGS. 2 and 4A. In some embodiments, the main cell converter circuitry may transform and/or transmit power at medium voltage (MV) levels.

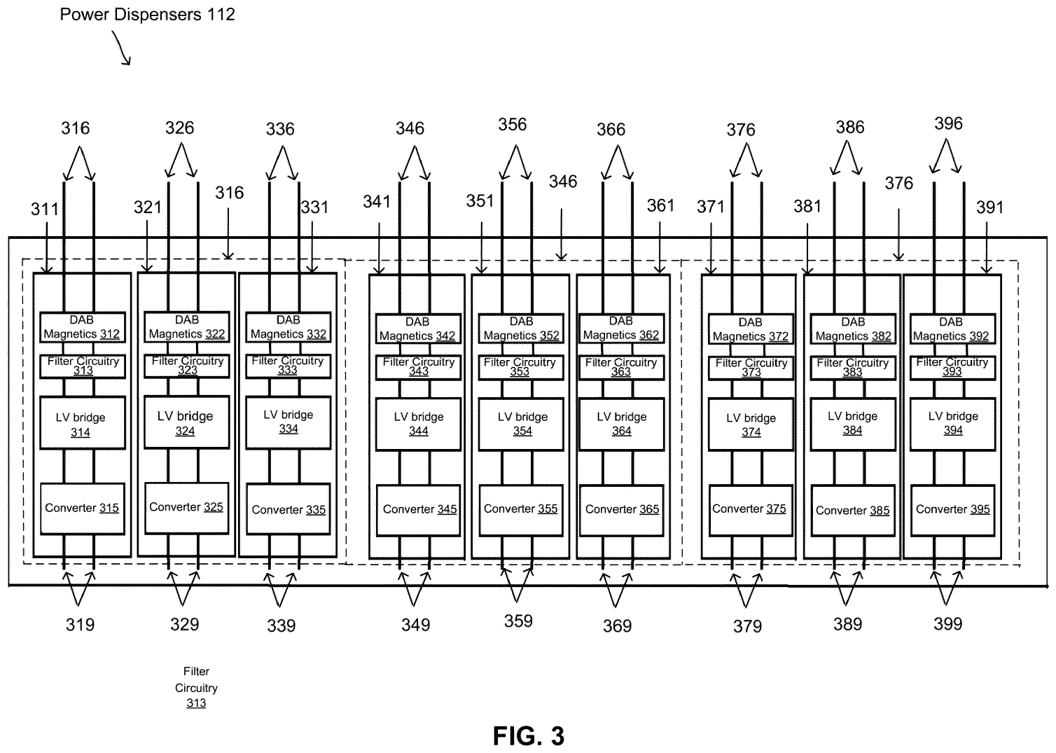

Each power dispensing system 116 includes a power dispenser 112 and a power dispenser controller 115. In some embodiments, each power dispenser 112 includes power dispenser converter circuitry, which may correspond to DAB magnetics and a secondary bridge of a DAB, as illustrated in FIGS. 3 and 4A. In some embodiments, the power dispenser converter circuitry may transform and/or transmit power at low voltage (LV) levels.

In some embodiments, a main cell 102 of a main cell system 104 at the main substation 106 obtains power from an electric grid, transforms the power into different forms such as direct current (DC) or alternating current (AC) and/or different voltages, and delivers the transformed power via transmission lines 120 to a power dispenser 112 of the power dispensing system 116. The power dispenser of the power dispensing system 116 receives the power from the transmission lines 120, transforms the power, and delivers the transformed power to an entity.

In some embodiments, the main substation 106 includes one or more main cells 102, each main cell being configured to supply power to a respective power dispenser 112. Each power dispenser 112 may be connected via the transmission lines 120 to a respective main cell 102. Each power dispenser 112 may be configured to provide power to an entity.

The main cell controller 105 may include circuitry, as well as software, hardware, and/or firmware, to control operations of the main cell 102. The power dispenser controller 115 may include circuitry, as well as software, hardware, and/or firmware, to control operations of the power dispenser 112.

In some embodiments, the main cell controller 105 and the power dispenser controller 115 may synchronize power transmission between each main cell 102 and its corresponding power dispenser 112 in either direction (forward or reverse). The synchronizing of power transmission may include coordinating switching operations depending on the direction of power flow. When operating in a forward or reverse mode, the main cell controller 105 and the power dispenser controller 115 may activate different control circuitry (forward or reverse control circuitry) within each main cell 102 and power dispenser 112.

During forward mode, the main cell controller 105 may operate in an independent mode and the power dispenser controller 115 may operate in a dependent mode. When operating in independent mode, the main cell controller 105 uses independent mode control circuitry to independently generate the main cell converter circuitry waveforms. When operating in dependent mode, the power dispenser controller 115 uses dependent mode control circuitry to generate power dispenser converter circuitry waveforms that depend upon a power dispenser trigger signal. The power dispenser trigger signal may be rising edges in secondary side voltages of the magnetic component circuitry. The rising edges may trigger a digital counter which triggers a state machine to change a state. The change of state triggers generating of the power dispenser converter circuitry waveforms. Thus, the rising edges trigger a timing when the power dispenser converter circuitry waveforms are to be generated, which influences a timing at which certain switches within the LV bridge of the power dispenser 112 are to be switched ON. This control of timing modulates a phase shift angle of the power dispenser converter circuitry waveforms with respect to the main cell converter circuitry waveforms.

During reverse mode, the power dispenser controller 115 may operate in an independent mode and the main cell controller 105 may operate in a dependent mode. When operating in independent mode, the power dispenser controller 115 uses independent mode control circuitry to independently generate power dispenser converter circuitry waveforms. When operating in dependent mode, the main cell controller 105 uses dependent mode control circuitry to generate main cell converter circuitry waveforms that depend upon a main cell trigger signal. The main cell trigger signal may be primary side current exceeding a current threshold. The primary side current may be measured at the primary side of the DAB magnetics, specifically, at the primary side of the transformers. When the primary side current exceeds the current threshold, a time-controlled state machine is caused to change a state. The change in state triggers generating of the main cell converter circuitry waveforms. Thus, the primary side current exceeding the current threshold signals a timing at which the main cell converter circuitry waveforms are to be generated, which influences a timing at which certain switches within the MV bridge of the main cell 102 are to be switched ON. This control of timing modulates a phase shift angle of the main cell converter circuitry waveforms with respect to the power dispenser converter circuitry waveforms.

The main cell controller 105 and/or power dispenser controller 115 may also configure the waveforms to regulate main cell 102 and/or power dispenser 112 voltages, whether the distributed power dispensing network 100 is operating in forward mode or reverse mode. Voltage regulation may be effected by adjusting the duty cycles of the MV bridge output waveforms or LV bridge output waveforms. Alternatively, the distributed power dispensing network 100 may use voltage choppers.

FIG. 2 is a diagram of example set of main cells (e.g., the main cells 102) within the distributed power dispensing network 100, according to some embodiments of the present invention. The main cells 102 include one or more MV circuit subsystems 216, 246, and/or 276. Each MV circuit subsystem 216, 246, or 276 may include one or more main cells. Main cells 211, 221, and 231 together comprise the MV circuit subsystem 216. Main cells 241, 251, and 261 together comprise the MV circuit subsystem 246. Main cells 271, 281, and 291 together comprise the MV circuit subsystem 276. Although three MV circuit subsystems and three main cells in each MV circuit subsystem are shown, the main cells 102 may include any number of MV circuit subsystems and any number of main cells. In some embodiments, the main cells 211, 221, and 231 may be cascaded together. In some embodiments, the main cells 241, 251, and 261 may be cascaded together. In some embodiments, the main cells 271, 281, and 291 may be cascaded together. Lines 210, 240, and 270 may connect to an electric network, such as an electric grid. Power may be supplied from the lines 210, 240, and 270 into the MV circuit subsystems 216, 246, and 276, respectively. Power may be filtered by LC filter and inductor 206, 207, and 208, respectively, at the lines 210, 240, and 270. The lines 210, 240, and 270 may be connected to a MV switchgear and protection circuitry 205. Lines 215, 225, 235, 245, 255, 265, 275, 285, and 295 may connect the respective main cells 211, 221, 231, 241, 251, 261, 271, 281, and 291 to corresponding terminals of the power dispenser 112.

In some embodiments, the main cells 211, 221, 231, 241, 251, 261, 271, 281, and 291 may include main cell converter circuitry that transforms and/or transmits power through the main cells 211, 221, 231, 241, 251, 261, 271, 281, and 291 in either direction. In some embodiments, the main cell 211 comprises a MV AFE 212, a MV DC link 213, and a MV bridge 214 coupled to one another. Similarly, the main cell 221 comprises a MV AFE 222, a MV DC link 223, and a MV bridge 224 coupled to one another. The main cell 231 comprises a MV AFE 232, a MV DC link 233, and a MV bridge 234 coupled to one another. The main cell 241 comprises a MV AFE 242, a MV DC link 243, and a MV bridge 244 coupled to one another. The main cell 251 comprises a MV AFE 252, a MV DC link 253, and a MV bridge 254 coupled to one another. The main cell 261 comprises a MV AFE 262, a MV DC link 263, and a MV bridge 264 coupled to one another. The main cell 271 comprises a MV AFE 272, a MV DC link 273, and a MV bridge 274 coupled to one another. The main cell 281 comprises a MV AFE 282, a MV DC link 283, and a MV bridge 284 coupled to one another. The main cell 291 comprises a MV AFE 292, a MV DC link 293, and a MV bridge 294 coupled to one another. Each MV AFE (e.g., the MV AFE 212, 222, 232, 242, 252, 262, 272, 282, and 292) includes a transformer-based rectifier that converts AC power to DC power in the forward direction. Each MV DC link (e.g., the MV DC link 213, 223, 233, 243, 253, 263, 273, 283, and 293) is a junction between the MV AFE and the MV bridge. Each MV DC link smooths DC power outputted at the MV AFE, reduces transmission of transient signals from the MV AFE, and/or reduces voltage fluctuations. Each MV bridge (e.g., the MV bridge 214, 224, 234, 244, 254, 264, 274, 284, and 294) includes a primary bridge of a DAB, which may be controlled to operate as an inverter that converts DC power to AC power in forward mode. AC power outputted from the MV bridge is transmitted to the power dispenser 112. Although each main cell is illustrated as having a MV AFE, a MV DC link, and a MV bridge, it is understood that any of the main cells may include fewer or additional components.

FIG. 3 is a diagram of an example set of power dispensers (e.g., the power dispensers 112) within the distributed power dispensing network 100, according to some embodiments of the present invention. The power dispensers 112 includes one or more LV circuit subsystems 316, 346, and/or 376. Each LV circuit subsystem may include one or more power dispensers. Power dispensers 311, 321, and 331 together comprise the LV circuit subsystem 316. Power dispensers 341, 351, and 361 together comprise the LV circuit subsystem 346. Power dispensers 371, 381, and 391 together comprise the LV circuit subsystem 376. Although three LV circuit subsystems and three power dispensers in each LV circuit subsystem are shown, each of the power dispensers 112 may include any number of LV circuit subsystems and any number of power dispensers. Lines 316, 326, 336, 346, 356, 366, 376, 386, and 396 may connect to the lines 215, 225, 235, 245, 255, 265, 275, 285, and 295, respectively. Power may be supplied from the lines 215, 225, 235, 245, 255, 265, 275, 285, and 295 into the lines 316, 326, 336, 346, 356, 366, 376, 386, and 396, respectively, or vice versa, via the transmission lines 120. Lines 319, 329, 339, 349, 359, 369, 379, 389, and 399 may connect the respective power dispensers 311, 321, 331, 341, 351, 361, 371, 381, and 391 to different entities that draw power.

In some embodiments, the power dispensers 311, 321, 331, 341, 351, 361, 371, 381, and 391 may include power dispenser converter circuitry that transforms and/or transmits power through the power dispensers 311, 321, 331, 341, 351, 361, 371, 381, and 391 in either direction. In some embodiments, the power dispenser 311 comprises DAB magnetics 312, filter circuitry 313, a LV bridge 314, and a converter 315 coupled to one another. Similarly, the power dispenser 321 comprises DAB magnetics 322, filter circuitry 323, a LV bridge 324, and a converter 325 coupled to one another. The power dispenser 331 comprises DAB magnetics 332, filter circuitry 333, a LV bridge 334, and a converter 335 coupled to one another. The power dispenser 341 comprises DAB magnetics 342, filter circuitry 343, a LV bridge 344, and a converter 345 coupled to one another. The power dispenser 351 comprises DAB magnetics 352, filter circuitry 353, a LV bridge 354, and a converter 355 coupled to one another. The power dispenser 361 comprises DAB magnetics 362, filter circuitry 363, a LV bridge 364, and a converter 365 coupled to one another. The power dispenser 371 comprises DAB magnetics 372, filter circuitry 373, a LV bridge 374, and a converter 375 coupled to one another. The power dispenser 381 comprises DAB magnetics 382, filter circuitry 383, a LV bridge 384, and a converter 385 coupled to one another. The power dispenser 391 comprises DAB magnetics 392, filter circuitry 393, a LV bridge 394, and a converter 395 coupled to one another. Each of the DAB magnetics (e.g., the DAB magnetics 312, 322, 332, 342, 352, 362, 372, 382, and 392) may represent magnetic component circuitry, and may include a transformer and associated circuitry such as one or more capacitors and/or inductors in series with the transformers. The DAB magnetics may exchange power between each MV bridge and LV bridge. The transformer may include a high frequency transformer, and may have a n:1 transformer ratio. Each of the filter circuitry (e.g., the filter circuitry 313, 323, 333, 343, 353, 363, 373, 383, and 393) may include power conditioning LC filters. Each of the LV bridges (e.g., the LV bridges 314, 324, 334, 344, 354, 364, 374, 384, and 394) may include a LV bridge, or a secondary bridge, of the DAB. The LV bridge may be controlled to operate as a rectifier that converts AC power to DC power in forward mode.

Each of the converters (e.g., the converters 315, 325, 335, 345, 355, 365, 375, 385, and 395) may include DC-DC converters. In some embodiments, the converters may include filtering components such as harmonic filtering components and one or more other regulating components to counteract voltage sags or swells, and/or one or more circuit breakers. The converters may deliver the power to the entities via the lines 319, 329, 339, 349, 359, 369, 379, 389, and/or 399. In some embodiments, power levels of the DC-DC converters may range from between 10 kw to 10 megawatts (mw).

FIG. 4A is a diagram of example distributed power dispensing network 400 and circuitry within the main cell 102 and the power dispenser 112, according to some embodiments of the present invention. The distributed power dispensing network 400 may include the MV bridge 214, DAB magnetics 316 and the LV bridge 314. The MV bridge 214 includes switches 422, 424, 426 and 428. The LV bridge 314 includes switches 432, 434, 436, and 438. The DAB magnetics 316 includes transformer 430 with one or more other magnetic components such as a capacitor 429 and/or inductors 431. The transformer 430 may have a n:1 transformer ratio. Power may be exchanged between the MV bridge 214 and the LV bridge 314 via the transformer 430.

The distributed power dispensing network 400 may further include a power source 401 and an input capacitor 403. The power source 401 may represent an output from a MV DC link (e.g., the MV DC link 213). The distributed power dispensing network 400 may further include an output load 402 and an output capacitor 450. The output load 402 may represent an entity that is drawing (or providing) power.

The MV bridge 214 may include complementary switch pairs including the switches 422 and 428 and the switches 424 and 426. The LV bridge 314 may include complementary switch pairs including the switches 432 and 438 and the switches 434 and 436. Each of the switches may include diodes and/or capacitors that reduce reverse conduction losses and limit voltage slew rate, respectively. The diodes may represent internal parasitic diodes of the switches 422, 424, 426, 428, 432, 434, 436, and 438 and/or additional external diodes. The capacitors illustrated may represent internal capacitances of the switches 422, 424, 426, 428, 432, 434, 436, and 438 and/or may represent additional capacitances. In particular, the converter circuit 400 may include a diode 412 and a capacitor 423 in parallel with the switch 422, a diode 414 and a capacitor 415 in parallel with the switch 424, a diode 416 and a capacitor 417 in parallel with the switch 426, a diode 418 and a capacitor 419 in parallel with the switch 428, a diode 442 and a capacitor 443 in parallel with the switch 432, a diode 434 and a capacitor 445 in parallel with the switch 434, a diode 446 and a capacitor 447 in parallel with the switch 436, and a diode 448 and a capacitor 449 in parallel with the switch 438.

In context with FIGS. 1-3, the switches 422, 424, 426, and 428 comprise an MV bridge (e.g., the MV bridge 214, 224, 234, 244, 254, 264, 274, 284, and/or 294). In some embodiments, the transformer 430 in cooperation with the one or more other magnetic components, such as the capacitor 429 and/or the inductor 431, comprise DAB magnetics (e.g., the DAB magnetics 312, 322, 332, 342, 352, 362, 372, 382, and/or 392). In some embodiments, the switches 432, 434, 436, and 438 comprise an LV bridge (e.g., the LV bridge 314, 324, 334, 344, 354, 364, 374, 384, and/or 394).

The main control system 105 may control switching of the switches 422, 424, 426, and 428. The power dispenser controller 115 may control switching of the switches 432, 434, 436, and 438. The main control system 105 and power dispenser controller may control switching by controlling the gate voltages of each of the switches 422, 424, 426, 428, 432, 434, 436, and 438, e.g., using the main cell converter circuitry waveforms and/or power dispenser converter circuitry waveforms. By controlling the complementary pairs of switches, each of the main cell controller 105 and the power dispenser controller 115 may control the MV bridge 214 and the LV bridge 312 respectively to operate as an inverter or a rectifier based on whether the network is operating in forward or reverse mode. In such a manner, the distributed power dispensing network 400 enables bidirectional power transfer.

An example cycle within the MV bridge may include the following operations:
1. a first operation cycle, in which the switches 422 and 428 are in an ON state while the transistors 426 and 424 are in an OFF state,
2. a first dead time in which the switches 426, 424, 422, and 428 are all in an OFF state,
3. a second operation cycle in which the switches 426 and 424 are in an ON state while the switches 422 and 428 are in an OFF state,
4. a second dead time in which the switches 426, 424, 422, and 428 are all in an OFF state,
5. followed by the first operation cycle.

Similarly, an example cycle within the LV bridge may include the following operations:
1. a third operation cycle in which the switches 432 and 438 are in an ON state while the switches 436 and 434 are in an OFF state,
2. a third dead time in which the switches 436, 434, 432, and 438 are all in an OFF state,
3. a fourth operation cycle in which the switches 436 and 434 are in an ON state while the switches 432 and 438 are in an OFF state,
4. a fourth dead time in which the switches 436, 434, 432, and 438 are all in an OFF state,
5. followed by the third operation cycle.

In some embodiments, the main cell controller 105 and the power dispenser controller 115 may synchronize the timing of switching operations between the main cell 102 and the power dispenser 112. That is, in forward mode, the power dispenser controller 115 may control the LV bridge 314 to operate synchronously with the incoming signal from the transformer 430 from the MV bridge 214 (which is operating independently). In reverse mode, the main cell controller 105 may control the MV bridge 214 to operate synchronously with the incoming signal from the transformer 430 from the LV bridge 314 (which is operating independently).

In order to coordinate the distributed power dispensing network 100 to synchronize power transmission, the direction of power flow may need to be communicated between the power dispenser controller 115 and the main cell controller 105. In some embodiments, communication of the direction of power flow may be effected using one or more wireless modules 470 and 472. In some embodiments, the main cell controller 105 may obtain a signal indicative of a direction of power flow from the power dispenser controller 115. Depending on the direction of power flow, the main cell controller 105 and the power dispenser controller 115 may activate particular control circuitry corresponding to the forward or the reverse mode. If the direction of power flow is forward, the main cell controller 105 and the power dispenser controller 115 may activate respective forward mode control circuitry (circuitry within the main cell controller 105 to operate independently and circuitry within the power dispenser controller 115 to operate dependently). If the direction of power flow is reverse, the main cell controller 105 and the power dispenser controller 115 may activate reverse mode control circuitry (circuitry within the power dispenser controller 115 to operate independently and circuitry within the main cell controller 105 to operate dependently).

The forward mode control circuitry in the main cell controller 105 independently generates main cell converter circuitry waveforms. Independent may be construed to mean that the main cell controller 105 does not require or depend upon any trigger signal to generate the main cell converter circuitry waveforms. The main cell converter circuitry waveforms control switching states of the switches 422 and 428, and 426 and 424.

The forward mode control circuitry in the power dispenser controller 115 generates power dispenser converter circuitry waveforms in dependent mode. In dependent mode, the power dispenser controller 115 may generate power dispenser converter circuitry waveforms in a process that depends upon the power dispenser trigger signal. This power dispenser trigger signal may be a rising voltage V_{S} across the secondary side of the transformer 430. This voltage may be obtained from a voltage sensor 462. Upon detecting the rising edge of voltage V_{S}, the power dispenser controller 115 may trigger a digital counter, which triggers a state machine to change a state. This change in the state triggers generating of the power dispenser converter circuitry waveforms. The power dispenser converter circuitry waveforms control switching states of the switches 432 and 438, and 436 and 434. The generating of power dispenser converter circuitry waveforms in the dependent mode enables phase shift modulation of the power dispenser converter circuitry waveforms with respect to the main cell converter circuitry waveforms.

The reverse mode control circuitry in the power dispenser controller 115 independently generates power dispenser converter circuitry waveforms. Independent may be construed to mean that, to generate the power dispenser converter circuitry waveforms, the power dispenser controller 115 does not require or depend upon any trigger signal.

The reverse mode control circuitry in the main cell controller 105 generates main cell converter circuitry waveforms in dependent mode. In dependent mode, the main cell controller 105 may generate main cell converter circuitry waveforms in a process that depends upon a main cell trigger signal. This main cell trigger signal may be a rising current I_{MV} based on a sampling of the rising current, I_{P}, across the primary side of the transformer 430, e.g., that exceeds a threshold current. This main cell trigger signal may be detected by a current sensor 460. When the rising current I_{MV} or I_{P} exceeds the threshold current, the main cell controller 105 changes a state of a state machine, which causes generating of the main cell converter circuitry waveforms. The generating of the main cell converter circuitry waveforms in the dependent mode enables phase shift angle modulation of the main cell converter circuitry waveforms with respect to the power dispenser converter circuitry waveforms. In some embodiments, by adjusting the threshold current, the main cell controller 105 may modify the phase shift angle.

The wireless modules 470 and 472 may be configured to obtain and/or communicate a direction of power flow between the main cell controller 105 and the power dispenser controller 115. The wireless modules 470 and/or 472 may include software, hardware, and/or firmware configured communicate via one or more wide area networks (WANs) or local area networks (LANs), public, private, IP-based, non-IP based, networks, and so forth. The wireless modules 470 and 472 may contain transceivers and antennae. Wireless communication may implement various protocols such as 802.11 a/b/g/n, WiMax, LTE, WiFi.

FIG. 4B is a diagram of an example power dispenser system (e.g., the power dispenser system 116), according to some embodiments of the present invention. The power dispenser system 116 may be coupled to transmission lines 482 (e.g., the transmission lines 120) from the main substation 106, which may be disposed under ground 480. The power dispenser system 116 may receive and/or transmit power to the transmission lines 482. The transmission lines 482 may connect between lines (e.g., the lines 215) of the main cell 102 and corresponding lines (e.g., the lines 316) of the power dispenser 112. The power dispenser 112 may include lines (e.g., the lines 319) that connect to an entity that draws power from the power dispenser 112. The lines 319 may include charging guns. The power dispenser 112 may include one or more stations and/or one or more charging guns which may be customized based on a Megawatt Charging System.

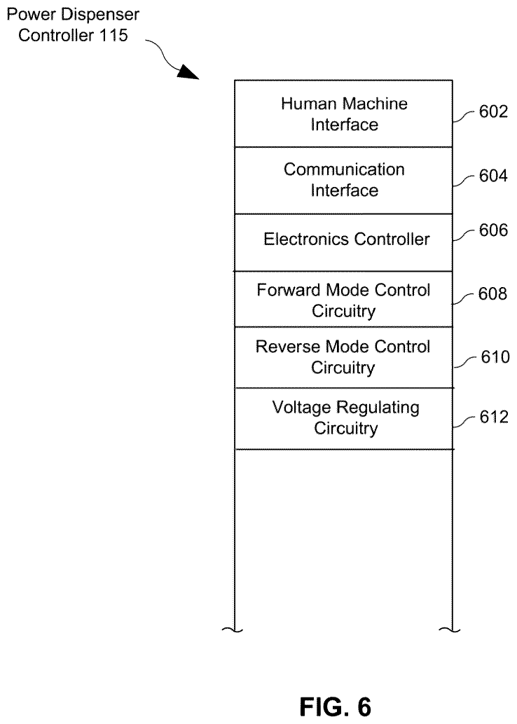

The power dispenser system 116 may include the power dispenser controller 115, the converter 315, the LV bridge 314, the DAB magnetics 312, a circuit breaker 486, and wireless module 472. The power dispenser controller 115 (as illustrated in FIG. 6) includes a human machine interface (HMI). The HMI may receive a request for power (forward or reverse) and one or more parameters of power delivery, and may initiate instructions to effect the delivery of power. The wireless module 472 may communicate the direction of power flow to the main cell system 104. The circuit breaker 486 may detect a fault and shut down the power dispenser system 116.

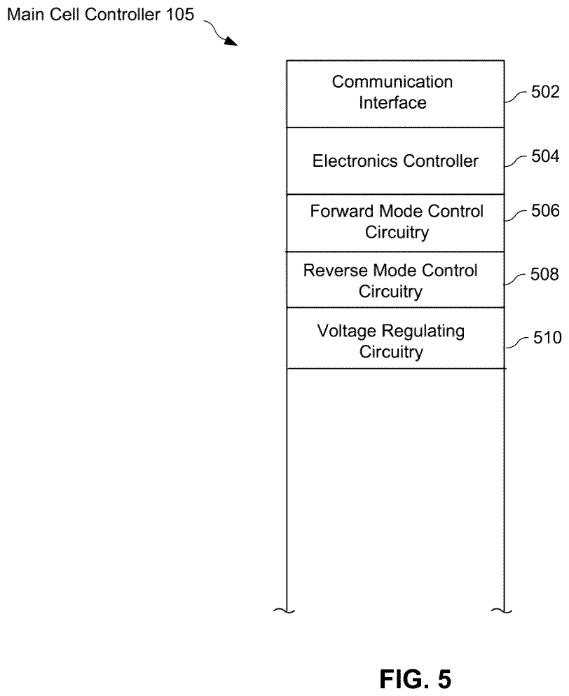

FIG. 5 is a block diagram illustrating details of the main cell controller 105, which controls the main cell 102. The main cell 102 may include any of the main cells 215, 225, 235, 245, 255, 265, 275, 285, or 295. In some embodiments, the main cell controller 105 includes a communication interface 502, an electronics controller 504, forward mode control circuitry 506, reverse mode control circuitry 508, and voltage regulating circuitry 510. The communication interface 502 may cooperate with the wireless module 470 to enable communication with the power dispenser controller 115. In some embodiments, the communication interface 502 may receive a power flow direction signal using the wireless module 470 from the power dispenser controller 115. The communication interface 502 may pass the flow direction signal to the electronics controller 504. The electronics controller 504 may, according to the flow direction, activate either the forward mode control circuitry 506 or the reverse mode control circuitry 508. That is, when the power flow direction is forward, the electronics controller 504 activates the forward mode control circuitry 506. When the power flow direction is reverse, the electronics controller 504 may activate the reverse mode control circuitry 508.

The forward mode control circuitry 506, when activated, is configured to independently generate main cell converter circuitry waveforms.

The reverse mode control circuitry 508, when activated, is configured to generate main cell converter circuitry waveforms in dependent mode. In dependent mode, the reverse mode control circuitry 508 is configured to generate main cell converter circuitry waveforms in a process that depends upon the main cell trigger signal. As indicated above, this main cell waveform signal may be a rising current I_{MV} or a sampling of the rising current, I_{P}, across the primary side of the transformer 430, e.g., which may exceed a threshold current. This main cell trigger signal may be detected by the current sensor 460. The reverse mode control circuitry 508 may include a comparator, which detects when the rising current I_{MV} or the sampling of the rising current I_{P} exceeds the threshold current. When the rising current I_{MV} or I_{P} exceeds the threshold current, the reverse mode control circuitry 508 changes a state of a state machine, which causes generating of the main cell converter circuitry waveforms. In this manner, the reverse mode control circuitry 508 may synchronize power transmission when power is flowing in a reverse direction, so that timing is seamlessly controlled in a closed loop manner, without requiring fiber optic cables.

The voltage regulating circuitry 510 may monitor voltages, e.g., at the output of an MV bridge. The voltage regulating circuitry 510 may regulate the output voltage by adjusting duty cycles of the control circuitry waveforms.

FIG. 6 is a block diagram illustrating details of the power dispenser controller 115, which controls the power dispenser 112. In some embodiments, the power dispenser controller 115 includes a human machine interface (HMI) 602, a communication interface 604, an electronics controller 606, forward mode control circuitry 608, reverse mode control circuitry 610, and voltage regulating circuitry 612. In some embodiments, the HMI 602 is configured to receive a request to deliver power to an entity or to draw power from an entity. The HMI 602 obtains a direction of power flow. The communication interface 604 may cooperate with the wireless module 472 to enable communication with the main cell controller 105. In some embodiments, the communication interface 604 may transmit a power flow direction signal using the wireless control module 472 to the main cell controller 105. The electronics controller 606 may, depending on the power flow direction, activate either the forward mode control circuitry 608 or the reverse mode control circuitry 610. That is, when the power flow direction is forward, the electronics controller 606 may activate the forward mode control circuitry 608. When the power flow direction is reverse, the electronics controller 606 may activate the reverse mode control circuitry 610.

The forward mode control circuitry 608 of the power dispenser controller 115, when activated, dependently generates power dispenser converter circuitry waveforms. In dependent mode, the forward mode control circuitry 608 generates power dispenser converter circuitry waveforms in a process that depends upon a power dispenser trigger signal. This power dispenser trigger signal may be a rising voltage Vs across the secondary side of the transformer 430. This power dispenser trigger signal may be detected by the voltage sensor 462. Upon detecting the power dispenser trigger signal of the rising voltage V_{S}, the forward mode control circuitry 608 may trigger a digital counter, which triggers a state machine to change a state. This change in the state triggers generating of the power dispenser converter circuitry waveforms. The power dispenser converter circuitry waveforms controls the switching operations of the switches 432 and 438, and 436 and 434. The generating of power dispenser converter circuitry waveforms in the dependent mode enables phase shift modulation of the power dispenser converter circuitry waveforms with respect to the main cell converter circuitry waveforms. In this manner, the forward mode control circuitry 608 may synchronize switching when power is flowing in a forward direction, so that timing is seamlessly controlled in a closed loop manner, without requiring fiber optic cables.

The reverse mode control circuitry 610, when activated, is configured to independently generate power dispenser converter circuitry waveforms.

The voltage regulating circuitry 612 may monitor voltages, e.g., at the output of an LV bridge. The voltage regulating circuitry 612 may regulate the output voltage by adjusting duty cycles of control circuitry waveforms.

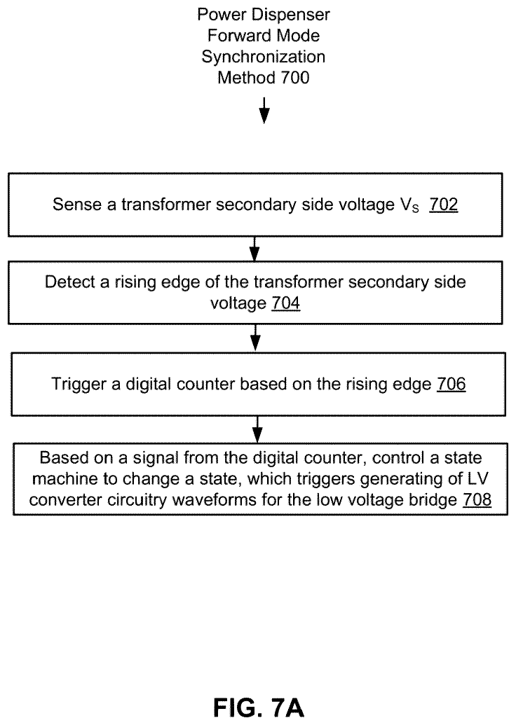

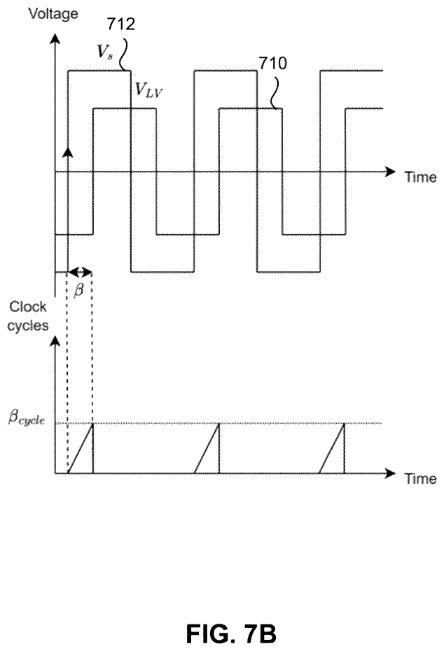

FIG. 7A is a flowchart of an example power transmission synchronization method 700 by the power dispensing system 116 in forward mode, in accordance with some embodiments of the present invention. In this and other flowcharts and/or sequence diagrams, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

Prior to implementing the method 700, the main cell controller 105 has independently generated main cell converter circuitry waveforms. As a result, power has been transmitted from the MV bridge of a main cell 102 (e.g., the MV bridge 214) to the secondary side of the transformer 430. The method 700 begins with step 702, in which the power dispenser controller 115, in particular, the forward mode control circuitry 608, detects a transformer secondary side voltage V_{S}. V_{S} may be sensed across the secondary side of the transformer 430 by the voltage sensor 462. In step 704, the forward mode control circuitry 608 detects a rising edge, or an increase in value beyond a threshold, of the transformer secondary side voltage V_{S}, which is the power dispenser trigger signal. In step 706, the forward mode control circuitry 608 triggers a digital counter based on the rising edge. In step 708, the forward mode control circuitry 608, based on a signal from the digital counter indicating that the digital counter has been triggered, control a state machine to change a state. The change in the state triggers generating of the power dispenser converter circuitry waveforms.

FIG. 7B is a diagram illustrating example LV bridge output waveforms 710. In FIG. 7B, LV have a voltage amplitude of V_{LV}. The LV bridge output waveforms 710 have a phase shift angle β with respect to transformer secondary side waveforms 712, which have voltage amplitude V_{S}. In some embodiments, the phase shift angle β correlates to a phase shift angle of the power dispenser converter circuitry waveforms with respect to the main cell converter circuitry waveforms.

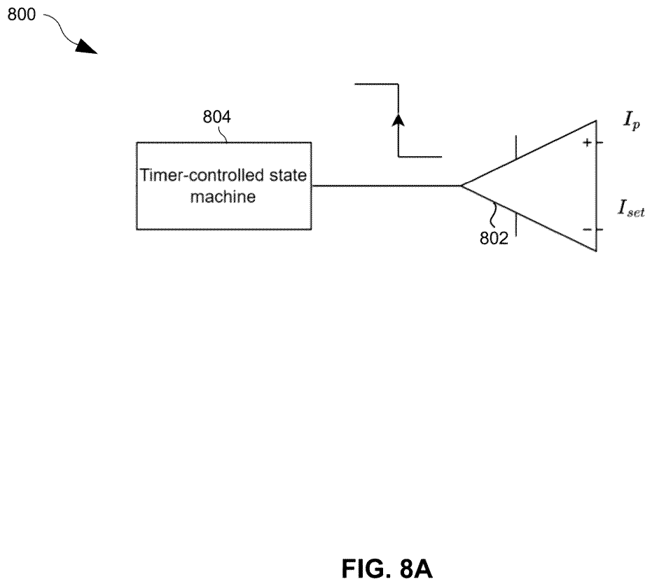

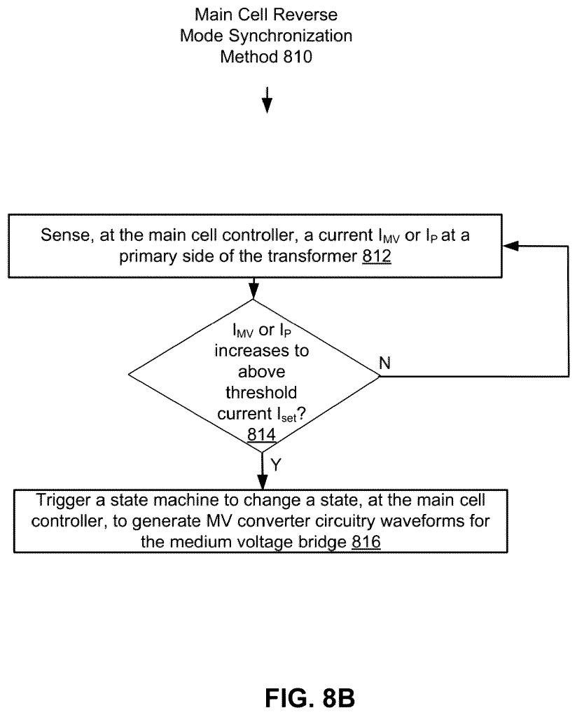

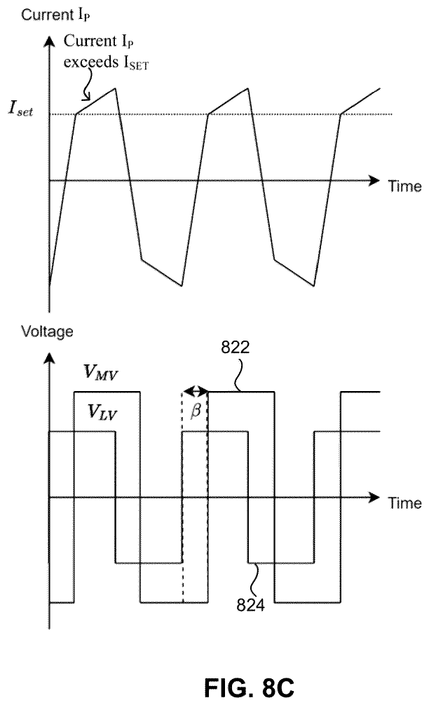

FIG. 8A is a diagram illustrating example reverse mode control circuitry (e.g., the reverse mode control circuitry 508) of the main cell controller 105 for power transmission synchronization in reverse mode, in accordance with some embodiments of the present invention. The reverse mode control circuitry 508 may include a comparator 1002, which compares a magnitude of a rising edge of a current I_{MV} or a sampled current I_{P} at a primary side of the transformers 430, with a threshold current I_{SET}. In some embodiments, the sampled current I_{P} may include a portion of the current I_{MV}. The comparator 1002 may output a signal upon detecting that the magnitude of the rising edge of a current I_{MV} or the sampled current I_{P} exceeds a threshold current I_{SET}. The signal may correspond to the main cell trigger signal which triggers a timer-controlled state machine 1004 to change a state. The change in the state of the timer-controlled state machine 1004 triggers generating of main cell converter circuitry waveforms.

FIG. 8B is a flowchart of an example method 810 of power transmission synchronization by a main cell controller 105 in reverse mode, in accordance with some embodiments of the present invention. Prior to implementing the method 810, the power dispenser controller 115 has independently generated power dispenser converter circuitry waveforms, resulting in LV bridge output waveforms having voltage amplitude V_{LV} at the secondary side of the transformer 430. Power has been transmitted from the LV bridge 314 of the power dispenser 112 onto the primary side of the transformer 430. Method 810 begins with step 812, in which the main cell controller 105, in particular, the reverse mode control circuitry 508, senses a rising edge of a current I_{MV} or a sampled current I_{P} at the primary side of the transformer 430. In decision 814, a comparator, which is part of the reverse mode control circuitry 508, outputs a signal indicating whether the current I_{MV} or the sampled current I_{P} has increased beyond the threshold current I_{SET}. In response to a negative determination, the method 810 loops back to step 812, in which the current I_{MV} or the sampled current I_{P} continues to be sensed. In response to a positive determination, the reverse mode control circuitry 508 outputs the main cell trigger signal which triggers a state machine to change a state. The changing of the state causes generating of main cell converter circuitry waveforms which regulate power flow through the main cell 112.

FIG. 8C is a diagram illustrating example MV bridge output waveforms 822, in accordance with some embodiments of the present invention. As shown in FIG. 8C, the MV bridge output waveforms 822 have voltage amplitude of V_{MV} and are phase shifted by β with respect to LV bridge output waveforms 824, which have voltage amplitude of V_{LV}. The phase shift angle β may also represent a phase shift angle of the main cell converter circuitry waveforms with respect to the power dispenser converter circuitry waveforms. A rising edge of the MV bridge output waveforms 822 may approximately coincide with a time instance at which the values of I_{MV} or I_{P} begin to exceed the threshold current I_{SET}. In some embodiments, the phase shift angle β may be adjusted by adjusting I_{SET}.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. References to “approximately” may be construed to encompass values within a certain range of the specified value, such as within 25 percent, 10 percent, 5 percent, 1 percent, 0.5 percent, 0.25 percent, 0.1 percent, or any other applicable value. In other embodiments, “approximately” may refer to a value or entity being within a design tolerance to achieve an objective or result.

Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A distributed solid state transformer (SST)-based power dispensing network, the distributed SST-based power dispensing network comprising:
a main cell system including a main cell and a main cell controller, the main cell having main cell converter circuitry, the main cell converter circuitry including a primary bridge of a dual active bridge (DAB), the main cell controller configured to control the primary bridge, the main cell controller configured to activate main cell forward mode control circuitry or main cell reverse mode control circuitry perform based on a direction of power flow; and
a power dispensing system including a power dispenser and a power dispenser controller, the power dispenser having power dispenser converter circuitry, the power dispenser circuitry including a secondary bridge of the DAB, the power dispenser controller configured to control the secondary bridge, the power dispenser controller configured to activate power dispenser forward mode control circuitry or power dispenser reverse mode control circuitry based on the direction of power flow.

2. The distributed solid state transformer (SST)-based power dispensing network of claim 1, wherein the main cell converter circuitry comprises a medium voltage (MV) bridge and the power dispenser converter circuitry comprises a low voltage (LV) bridge.

3. The distributed SST-based power dispensing network of claim 2, wherein the power dispenser converter circuitry comprises a transformer between the MV bridge and the LV bridge.

4. The distributed SST-based power dispensing network of claim 3,
wherein the activating of the main cell forward mode control circuitry comprises the main cell forward mode control circuitry independently generating main cell converter circuitry waveforms that regulate MV switching operations of switches within the MV bridge; and
wherein the activating of the power dispenser forward mode control circuitry comprises the power dispenser forward mode control circuitry dependently generating power dispenser converter circuitry waveforms that regulate LV switching operations of switches within the LV bridge.

5. The distributed SST-based power dispensing network of claim 4, wherein the power dispenser forward mode control circuitry generates the power dispenser converter circuitry waveforms in response to a power dispenser trigger signal that controls a phase shift angle.

6. The distributed SST-based power dispensing network of claim 5, wherein the power dispenser trigger signal is based on a rising edge of a secondary side voltage corresponding to a secondary side of the magnetic component circuitry.

7. The distributed SST-based power dispensing network of claim 6, wherein the power dispenser forward mode control circuitry in response to the power dispenser trigger signal, triggers a digital counter, which controls a state machine to change a state, the changed state causing generating of the power dispenser converter circuitry waveforms.

8. The distributed SST-based power dispensing network of claim 3,
wherein the activating of the main cell reverse mode control circuitry comprises the main cell reverse mode control circuitry causing dependently generating main cell converter circuitry waveforms that regulate MV switching operations of switches within the MV bridge; and
wherein the activating of the power dispenser reverse mode control circuitry comprises the power dispenser reverse mode control circuitry independently generating power dispenser converter circuitry waveforms that regulate LV switching operations of switches within the LV bridge.

9. The distributed SST-based power dispensing network of claim 8, wherein the main cell reverse mode control circuitry generates the main cell converter circuitry waveforms in response to a main cell trigger signal that controls a phase shift angle.

10. The distributed SST-based power dispensing network of claim 9, wherein the main cell trigger signal is based on a primary side current corresponding to a primary side of the magnetic component circuitry.

11. The distributed SST-based power dispensing network of claim 10, wherein the main cell trigger signal is based on a comparison of the primary side current against a threshold current.

12. The distributed SST-based power dispensing network of claim 11, wherein the main cell reverse mode control circuitry in response to the main cell trigger signal triggers a state machine to change a state, the changed state causing generating of the main cell converter circuitry waveforms.

13. The distributed SST-based power dispensing network of claim 1, wherein the main cell system and the power dispensing system are separately housed in different physical containers.

14. The distributed SST-based power dispensing network of claim 1, wherein the main cell comprises a main cell communication interface and the power dispenser comprises a power dispenser communication interface, and wherein the direction of the power flow is communicated wirelessly from the power dispenser communication interface to the main cell communication interface.

15. A method implemented by a distributed SST-based power dispensing network, the distributed SST-based power dispensing network comprising a main substation and a power dispensing system, the main substation comprising a main cell system including a main cell and a main cell controller, the main cell having main cell converter circuitry, the main cell converter circuitry including a primary bridge of a dual active bridge (DAB), the main cell controller configured to control the primary bridge, the power dispensing system including a power dispenser and a power dispenser controller, the power dispenser having power dispenser converter circuitry, the power dispenser circuitry including a secondary bridge of the DAB, the power dispenser controller configured to control the secondary bridge, the method comprising:
activating, by the main cell controller, main cell forward mode control circuitry or main cell reverse mode control circuitry perform based on a direction of power flow; and
activating, by the power dispenser controller, power dispenser forward mode control circuitry or power dispenser reverse mode control circuitry based on the direction of power flow.

16. The method of claim 15, further comprising transmitting power, at a medium voltage (MV) bridge of the main cell converter circuitry, at a medium voltage level and transmitting power, at a low voltage (LV) bridge of the power dispenser converter circuitry, at a low voltage level.

17. The method of claim 16, further comprising converting power from the medium voltage level to the low voltage level by a transformer between the MV bridge and the LV bridges.

18. The method of claim 17, wherein the activating of the main cell forward mode control circuitry comprises the main cell forward mode control circuitry independently generating main cell converter circuitry waveforms that regulate MV switching operations of switches within the MV bridge; and
wherein the activating of the power dispenser forward mode control circuitry comprises the power dispenser forward mode control circuitry dependently generating power dispenser converter circuitry waveforms that regulate LV switching operations of switches within the LV bridge.

19. The method of claim 18, further comprising generating, by the power dispenser forward mode control circuitry, the power dispenser converter circuitry waveforms in response to a power dispenser trigger signal that controls a phase shift angle.

20. The method of claim 18, wherein the power dispenser trigger signal is based on a rising edge of a secondary side voltage corresponding to a secondary side of the magnetic component circuitry.
